(19) United States
(12) Patent Application Publication
(10) Pub. No.: US 2008/0271541 A1
(43) Pub. Date: Nov. 6, 2008

(54) Stability and load sensors for wheeled vehicles

(76) Inventor: Eli Neuman, Caesarea (IL)

Correspondence Address: ELI NEUMAN, 13 TARSHISH ST., CAESAREA, 38900, IL

(21) Appl. No.: 12/074,747

(22) Filed: Mar. 7, 2008

(30) Foreign Application Priority Data
May 3, 2007 (IL) 182948

(51) Int. Cl. G01L 1/00; G01M 1/00

(52) U.S. Cl. 73/767; 73/65.01

(57) ABSTRACT

A stability sensing and load monitoring system for wheeled vehicles, in particular for the construction and agricultural industries, is disclosed. The system is based on strain sensors mounted on each wheel such that the measured strain represents the load on this wheel. A power source and a local wheel controller are located near the strain sensors. The data from the strain sensors is processed by the local wheel controller and then wirelessly transmitted to a single central unit, located in the cabin. The central controller communicates with all four local wheel controllers, collects the data, and then processes it to calculate the total load on the vehicle, its center of gravity, and the stability status.

### BACKGROUND OF THE INVENTION

1. Field of the Invention

The present invention relates to the area of stability sensing and on board load monitoring for wheeled vehicles in general and in particular for trucks, off road vehicles, construction and agricultural vehicles, and mobile cranes.

2. Description of Related Art

Cranes and vehicles with hydraulic booms must sense and control their stability. A common stability sensing technique is to measure the extension of the boom, its orientation and elevation angles, and in addition to estimate or sense the load on the boom. Having collected these data a destabilizing moment can be calculated and compared to the allowed limits.

Being indirect and relying on approximation, this approach is not very accurate. It is also relatively expensive as several costly sensors are necessary.

A different approach is common in certain types of construction machines, like telescopic handlers etc, in which the rear axle is instrumented, normally with Extensometers, to sense the axle bending due to the forces which are transferred to the wheels. The controller of these machines watches for reduction of the bending of the axle, which in turn indicates less load on the rear wheels, more forward tipping moment, and reduction in forward stability.

While relatively inexpensive, these systems suffer inaccuracies, are sensitivity to steering actions, and are not capable of sensing lateral or backward stability.

### SUMMARY OF THE INVENTION

The present invention provides important information to operators of certain vehicles: stability warning, total load on the vehicle, and center of gravity. The stability information is based on a simple observation: objects which are supported on four points are about to lose stability when any two adjacent supports cease to transfer load to the ground. Although not a novel principle, its implementation is novel and is therefore part of the present invention.

Several types of mobile machines, serving the construction industry, agriculture and so on are not inherently stable and carry the risk of losing stability, toppling over and risking life and property. Other vehicles like trucks, although more stable, can be handled carelessly in driving and lose their stability as well. It has been therefore the goal of manufacturers of such machines and vehicles to use stability sensing and activate warning signals or stop or reverse machine functions when approaching instability is sensed. Total load monitoring is sought after to avoid maximum axle load regulations as well as to ensure structural safety.

Since the points of contact with the ground in all wheeled vehicles are the wheels, it is best to sense the load being transferred by the wheels to the ground and to watch for loss of said load in any two adjacent wheels. Furthermore, any load transferred by the wheel to the ground is equal to the load placed on the same wheel by the axle to which it is connected; and, since a load on any wheel creates stresses and strains inside the rim structure, with the word rim relating to the metal structure between the axle and the tire, these stresses and strains being roughly proportional to the magnitude of the load, the present invention uses stress or strain sensors in all the vehicle wheel rims to measure said loads. In an alternative design the wheel loads are sensed by detecting a distortion of the rim under load which in turn is expressed by a change in the position of the center of each wheel relative to the outer circumference of the same rim.

Information from the individual wheel sensors is wirelessly transmitted to a central controller (CC), usually installed in the cabin of the vehicle. Electrical power is supplied to the wheel sensors by batteries or by photovoltaic panels.

A number of devices can be used as strain sensors: proximity sensors, extensometers, strain gage bridges, strain gage half bridges, or special load cells known by the name “Gozinta”. Installed or bonded in selected locations on the rims of the wheels, these sensing elements in each wheel are wired to a small local wheel controller (LWC). The latter performs several functions: it controls the voltage supply and distributes it to each strain sensor in the wheel; it collects the output reading from each strain sensor, filters, amplifies and digitizes it, and then, using certain algorithms, processes all the individual strain sensor readings into one single number representing the load on the said wheel; and, finally, it wirelessly transmits the said resulting load value to the CC.

### BRIEF DESCRIPTION OF THE DRAWINGS

Referring to the drawings for the purpose of illustration only and not limitation, there are the following depictions:

FIG. 1 is a schematic cross section through a rim of a vehicle built according to the preferred embodiment.

FIG. 2 is a front view of the same rim faced from the extension of its center line.

FIG. 3 is a schematic representation of the entire system according to the present invention.

FIG. 4 is a cross section through a variation on the preferred embodiment, necessary with certain designs of the rims.

FIG. 5 depicts a front view of a different embodiment of the present invention, utilizing strain gages as sensors.

FIG. 6 is a cross section through the same embodiment as in FIG. 5.

### DETAILED DESCRIPTION OF THE PREFERRED EMBODIMENTS

Although specific embodiments of the present invention will now be described with reference to the drawings, it should be understood that such embodiments are by way of example only and merely serve to illustrate but a small number of the many possible specific embodiments which can represent applications of the principles of the present invention. Various changes and modifications obvious to one skilled in the art to which the present invention pertains are deemed to be within the spirit, scope, and contemplation of the present invention as further defined in the appended claims.

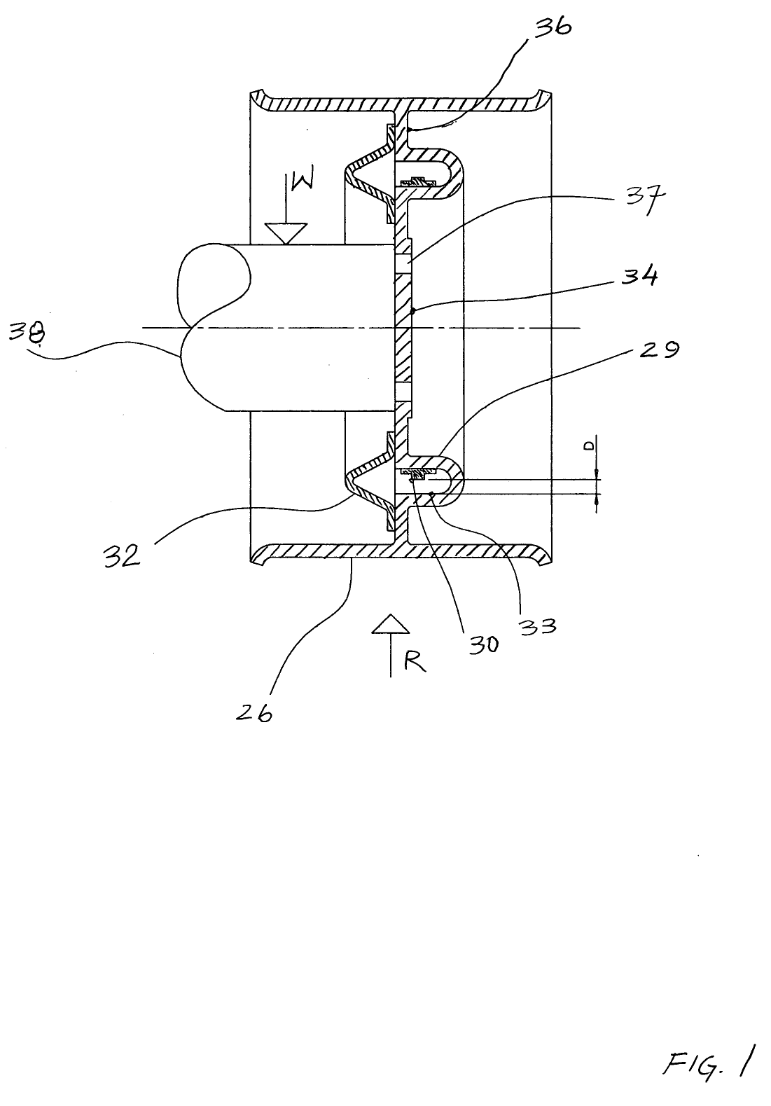

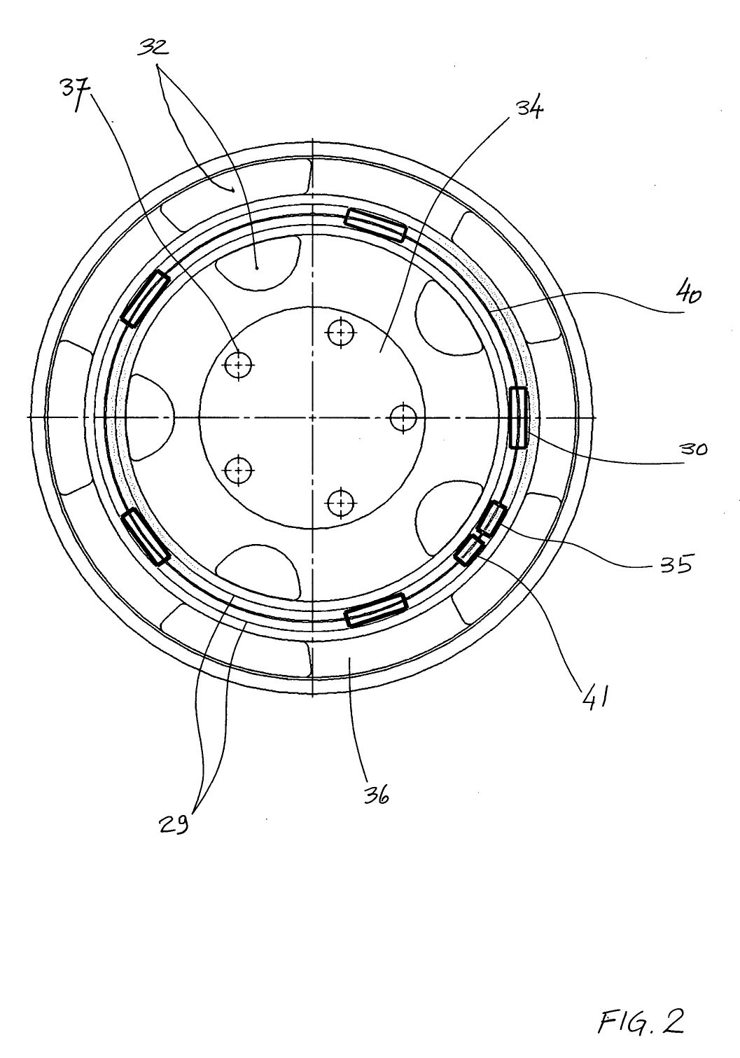

Referring to FIGS. 1 and 2, shown is a rim of a vehicle with FIG. 1 being a cross section and FIG. 2 a front view. The rim consists mainly of a round circumference part 26 on which a tire is installed, and a vertical wall 36 connected to 26 in the circumference and to a central area 34 which in turn is attached to axle 38 with a number of bolts passing through holes 37. Relief cuts 32 may or may not exist, depending on the practices in the rim manufacturing industry. The presence of cuts 32 or the absence thereof changes the stresses and strains in the rim and has to be taken in account for positioning the stress or strain sensors, but the present invention is valid for both situations.

For the purposes of the present invention, the rim according to the preferred embodiment consists of:
A folded channel 29, built into wall 36 either by bending the sheet metal of wall 36, as is shown in FIG. 1, or by welding a separately prepared folded part onto wall 36.
Proximity sensors or extensometers 30 installed inside folded channel 29.
Electric power source 35 installed inside folded channel 29.
Local wheel controller 41, installed inside folded channel 29.
Wiring 40, also installed inside folded channel 29 and connecting sensors 30, power source 35, and local wheel controller 41.
A rugged protective cover 32.

Folded channel 29 extends through the entire 360 degrees of the rim, whether cuts 32 exist or not. In the case of existence of windows 32, folded channel 29 continues through the windows leaving open area in one or both sides of itself depending on the layout of the said windows. Proximity sensors or extensometers 30 are installed on the mainly horizontal segment 39 of folded channel 29. At least two sensors are required, preferably located 90 degrees from each other, but more sensors are preferred for better output signal and higher accuracy. When using three or more sensors they are evenly separated. There exist a small distance d between each sensor and the opposing horizontal segment 31 of folded channel 29. Distance d changes under load W, and these changes are picked up by sensors 30 with the output of each sensor representing the local bending and stresses and strains. Since the wheel normally rotates when the vehicle is moving, and since the direction of loading is fixed with the reaction R always directed from the contact point of the tire on the ground upward to the rim center, it follows that distance d varies according to the momentary angular orientation relative to the rim's contact point on the ground. It is the assumption of the present invention that the combined reading of all sensors, when processed mathematically according to an appropriate algorithm, results in a number which is proportional to load W regardless of the current orientation of the rim/wheel. It is therefore the claim of the present invention that the combined reading of all sensors in an individual rim represents the load on same rim/wheel whether or not the vehicle is moving. However, in case the vehicle is moving, special processing of the readings can be utilized for better accuracy as follows: the reading from each sensor is highest when, due to the rotation of the rim, said specific sensor arrives closest to the ground contact point. Sequentially collecting the peak readings from all the sensors thus provides more data and enables averaging for all sensors for better accuracy.

Folded channel 29 serves two purposes:
A. Because the fold leads to bending stresses in itself as opposed to tension/compression taking place in a straight vertical wall 36, it provides an area with increased deflection when the rim is acted on by force W. Such increased deflection facilitates higher and better output from the sensors.
B. It provides a protective housing for sensors 30, wiring 40, local wheel controller 41, and power source 35. When covered on its open side by cover 32, there results a ruggedly protected space for all the elements in the system.

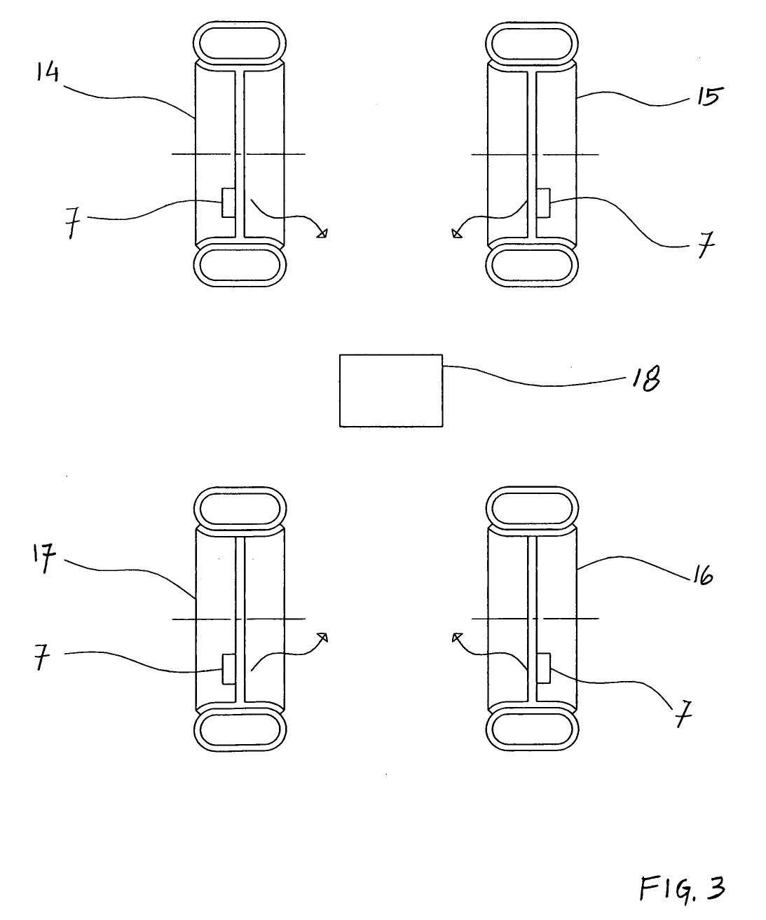

Local Wheel Controller (LWC) 41 is electrically connected to all the sensors as well as to the electric power source 35. It processes the outputs from the sensors and combines it into a single output signal which is proportional to the load W on the rim/wheel. Said output signal, which can be analog or digital, is then wirelessly transmitted to a the Central Controller in the cabin (CC, part 18 in FIG. 3), where it is displayed, used for alarms, warnings and control of vehicle functions in case instability or maximum load are approached. For the wireless transmission an antenna is connected to the LWC (not shown) such that it lies in the external side of folded channel 29 or cover 32, such antenna possibly consisting of an insulated wire bonded to the external metal surface of folded channel 29 or cover 32. Since the antenna is on the external side of the mentioned parts 29 and 32, the connecting wire to the LWC has to penetrate the metal through a small hole (again not shown). Said hole will be sealed around the wire; alternatively, a “glass to metal” device can be used for the same purpose.

The electric power supply in the preferred embodiment is a set of batteries located inside folded channel 29. To save on power consumption, LWC 41 will use techniques like sleep mode and low duty cycle for operating the sensors.

Cover 32 is made of metal formed with a fold of its own. That way, even when made of heavy and rugged steel to effectively protect the content of folded channel 29, it still presents low resistance to the bending of folded channel 29, thus retaining high outputs. Cover 32 will be held in place against vertical wall 36 by bolts, in which case it can be removed for maintenance or for battery replacement. Alternatively it can be welded in place leaving a short portion near the battery to be held by screws, this portion therefore serving as access door for replacement of batteries. A gasket seal between cover 32 and wall 36 will keep the system protected from the environment.

In the above mentioned embodiment, sensors 30 are called out as proximity sensors or extensometers. Both types, when properly selected, have the ability to detect very small distance shifts. Proximity sensors have an advantage in that they need to be installed on one side only with the other side serving as a target whose distance is sensed. Extensometers, on the other end, need to be clamped to both sides.

FIG. 3 was already mentioned briefly. It schematically depicts the entire stability and load sensing system according to the present invention. Items 14,15,16, and 17 are all the four wheels of a vehicle. Item 7 represents the LWC, 41 in FIG. 2, containing the wireless transmitter/receiver and its antenna. 18 is the central controller (CC) which in turn is located inside the cabin of the vehicle and which consists of receiving/transmitting circuits, software, power supplies fed by the vehicle power source, display means, operator input means, and control outputs like relays. CC 18 receives and transmits signals from and to each of the wheels, processes the information and arrives at several resulting numbers which represent the total load on the vehicle, load on each of the four wheels, center of gravity of the vehicle, and stability status. These results may then be displayed, warnings sound, and control output sent to activate or deactivate vehicle functions.

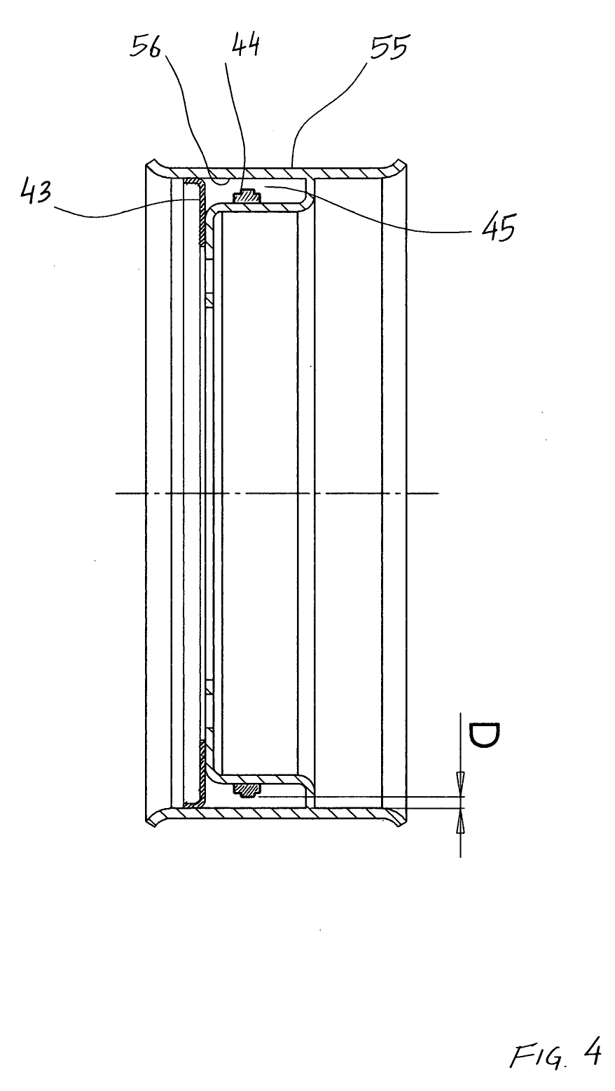

FIG. 4 depicts a cross section of a rim 55 built integrally with a “channel” 45. Such construction of the rim enables a the use of a simpler variation of the preferred embodiment. In this embodiment, integral channel 45 is used for the same purposes as the folded channel 29 in FIGS. 1 and 2, namely to provide bending deflection as well as to hold and protect the various system elements. Item 44 represents the proximity sensors or the extensometers which detect changes in distance d from the sensor to surface 56. As in the preferred embodiment above, the minimum number of sensors is two but three or more will provide better accuracy. Cover 43 seals and protects the parts in channel 45.

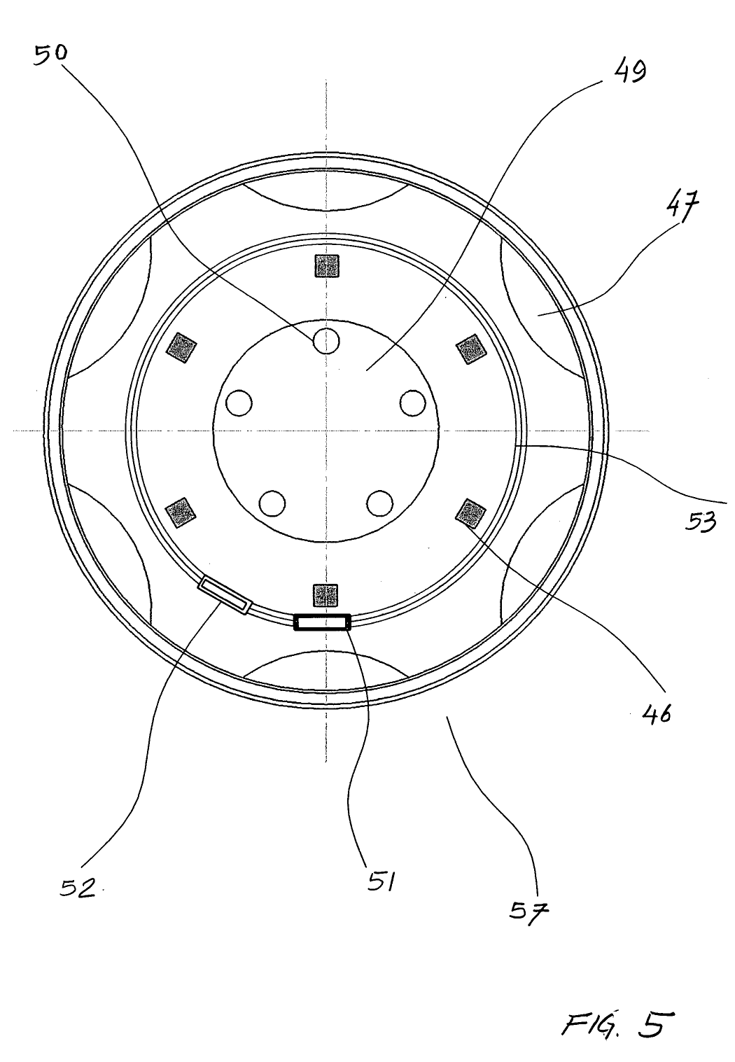

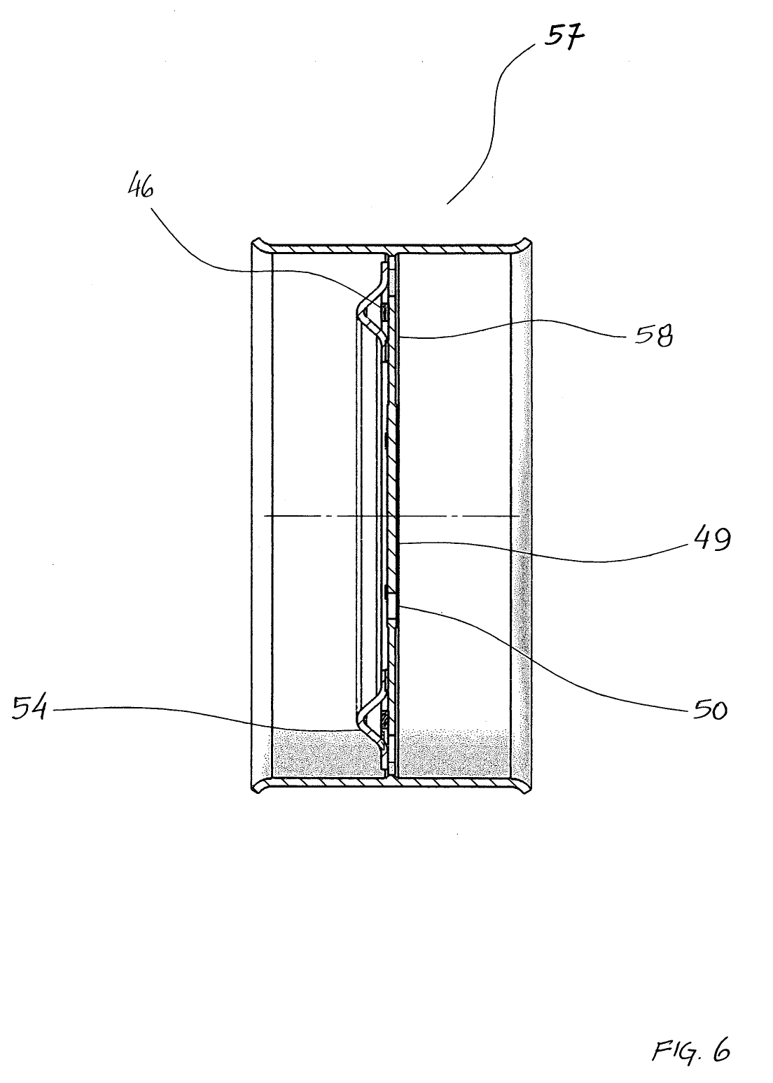

FIGS. 5 and 6 depict yet another embodiment of the present invention, based on strain gages as load sensors. FIG. 5 is a front view of a rim 57 and FIG. 6 is a cross section through it. Rim 57 may or may not have relief cuts 47, depending on the design of the rim itself. Strain gage bridges or half bridges 46 are bonded on vertical wall 58 in several locations, evenly distributed around the wheel. At least two bridges are needed but three or more will provide better accuracy. Wires 53 connect the bridges to LWC 51 and to electric power source 52. The rim is connected to its axle through area 49 with bolts passing through holes 50. A cover 54 is attached to wall 58 with bolts and serves to ruggedly protect the system components. Cover 54 is sealed against wall 58 with a gasket (not shown). When a load is applied on rim 57 in a manner similar to the one shown in FIG. 1, stresses and strains appear within wall 58 which are then detected by strain gage bridges 46. Mathematically combining all individual bridge readings can result in a number representing that said load.

Yet another embodiment is not shown but is based on replacing strain gage bridges with devices widely known as “Gozinta”. Each Gozinta is a load cell base on strain gages and has a general shape of a small and short cylinder sealed at both ends. Gozinta's are designed to be pressed inside holes in stressed members thus saving the need for bonding operation in the field. Once in place, the Gozinta senses the strains in the substrate in which it is pressed and in that way serves as a strain sensor.

Still another embodiment, again not shown, is based on replacing strain gage bridges with Extensometers.

I claim:

1. A stability sensing and load monitoring system for wheeled vehicles comprising:
A. on each wheel,
a. at least two strain sensors attached to or installed on the rim of each wheel, whereby rim refers not to a geometrical concept but to a generally circular shaped metal part connecting to a tire on its outer side and to an axle or a shaft or a hub in its inner side and is widely known as rim, said strain sensors installed in an area of said rim in which stresses and strains are generated by a load or force which in turn Is applied on each said wheel through an axle or shaft to which said wheel is connected, said stresses and strains being generally proportional in magnitude to said wheel load, and in which rim said strain sensors are being located with rotational symmetry around the center of said rim with their particular location being selected for high strain and ease of installation;
b. electrical wires connecting said strain sensors through a harness to a local wheel controller;
c. a local electronic wheel controller attached to same wheel, said controller comprising in turn,
(i) an electrical power source for its own circuits and for said strain sensors;
(ii) electronic circuits for amplifying, filtering, processing and digitizing signals from said strain sensors;
(iii) a wireless communication device including an antenna to communicate with a central stability controller located inside the vehicle, said communication consisting of transmitting strain readings to said central stability controller and receiving instructions from said central stability controller to transmit readings or to enter sleep mode or to wake up from said sleep mode;
(iv) an enclosure to hold securely in place and to protect said parts;
d. Protective cover installed over the strain sensors as well as over the connecting wires and harnesses and over the wheel controller;
B. and, in the vehicle itself, a single central stability controller and load monitor which receives readings from all rims/wheels and determines the stability status and total vehicle load as well as location of the center of gravity of the loaded vehicle, in turn comprising:
a. receiving and transmitting circuits and antenna, designed to communicate with each of said local wheel controllers, receiving wheel load signals from each of said local wheel controllers and transmitting instructions to said local wheel controllers to transmit readings or to enter sleep mode or to wake up;
b. an electronic circuit with microcontroller to process the incoming strain readings from all said wheels, monitor for loss of stability and activate audible or visual warnings or abort or change vehicle functions when so determined by said algorithms;
c. means for processing electrical power from said vehicle;
d. keys or buttons for operator input, buzzer for audio alarms, LED's or other lights for visual alarms, and means to affect vehicle functions, said means being relays connected to respective function controller in the vehicle;
e. an enclosure to hold securely in place and protect all said parts.

2. The invention as defined in claim 1 wherein said central stability controller monitors all said wheel strain readings and watches for simultaneous reduction in strain in any two adjacent wheels, interpreting this situation as an indication of approaching or existing vehicle instability.

3. The invention as defined in claim 1 wherein proximity sensors or extensometers are used as strain sensors, said proximity sensors or extensometers measuring each a distance between themselves and a target located near themselves, and whereby said measured distance is affected by load applied on said rim.

4. The invention as defined in claim 1 wherein a channel feature present or is built into the rim by creating a fold which extends for a full revolution and in which loads on said rim result in bending of said folded channel thus changing the width of the open end of said folded channel and in which proximity sensors or extensometers detect said change in the width of said folded channel with said width changes representing the load on said rim, and in which design said folded channel serves also to house and protect all said elements including said sensors, electrical wiring, local wheel controller and power source, and further in said design a strong metal cover is openably connected to said rim in the open side of said folded channel to protect said contents and still enable battery replacement and access to said contents.

5. The invention as defined in claim 1 wherein instead of strain sensors, position sensing is utilized to detect deflection under load of said rims and wheels, such deflection being expressed, among others, by the change in position of the center of said rims relative to the circumference of said rim, said position change resulting from a load placed on said wheel by an axle to which said wheel in connected, and in which said change in said wheel center position is roughly proportional to the magnitude of said wheel load, such that absence of said change in center position indicates zero wheel load or very low wheel load, and in which readings of said change in center position in each of said wheels are transmitted by said local wheel controller to said central stability controller to serve as the basis for stability monitoring instead of the strain sensors used I claim 1.

6. The invention as defined in all the claims above in which the electrical energy source in each wheel is electrical battery or batteries.

7. The invention as defined in claims 1 to 9 in which the electrical energy source is a photo Voltaic set of cells installed on the same rim.
